(19) United States
(12) Patent Application Publication
(10) Pub. No.: US 2007/0229930 A1
(43) Pub. Date: Oct. 4, 2007

(54) DIFFRACTION ELEMENT, OPTICAL PICKUP AND OPTICAL DISC APPARATUS

(75) Inventors: Jin Sato, Miyagi (JP); Takatoshi Yamada, Kanagawa (JP); Satoshi Kawakita, Tokyo (JP); Kyu Kanno, Miyagi (JP); Motoo Aiba, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/690,344

(22) Filed: Mar. 23, 2007

(30) Foreign Application Priority Data
Mar. 31, 2006 (JP) 2006-098708
Nov. 24, 2006 (JP) 2006-317460

(51) Int. Cl. G02B 26/08

(52) U.S. Cl. 359/204

(57) ABSTRACT

A diffraction element includes: an injection-molded transparent first member having two optical surfaces; and a second member firmly attached to one of the optical surfaces of the first member and provided with a first diffraction pattern on a surface, wherein the second member is a first ultraviolet curable resin having a refraction index in a range of ±0.013 with respect to a refraction index of the first member.

### CROSS REFERENCES TO RELATED APPLICATIONS

The present invention contains subject matter related to Japanese Patent Application JP2006-317460 filed in the Japanese Patent Office on Nov. 24, 2006, the entire contents of which being incorporated herein by reference.

### BACKGROUND OF THE INVENTION

1. Field of the Invention

The present invention relates to a diffraction element, optical pickup and optical disc apparatus, and is preferably applied to a diffraction element for various wavelengths, for example.

2. Description of the Related Art

Typically, an optical disc device includes an optical pickup in which a diffraction element is installed to correct an aberration of an optical beam. The diffraction element includes a diffraction grating with fine grooves on its transparent plate base. An optical path difference between the top and bottom of the diffraction grating diffracts the optical beam (see Jpn. Pat. Laid-open Publication No. 2005-339762, for example).

The diffraction efficiency of the diffraction element varies according to the depth of the grooves of the diffraction pattern of the diffraction grating and the wavelengths of the optical beam. In addition, its diffraction angles vary according to the diffraction pattern, or the width of the groove.

### SUMMARY OF THE INVENTION

To produce the diffraction element, injection molding process is often applied; the parts are generated by injecting optical plastics, or resins, into a mold. When using the injection molding to produce the diffraction element with fine grating and deep grooves, it is preferable to raise the resin filling rate of the mold to improve the reproducibility of the diffraction pattern or its transcription capability. However, in this case, the plastics and molds may be at high temperatures during the injection process. In addition, it is preferable to raise the temperature of the plastics to easily take the part from the mold after the injection process.

As a result, the injection-molded parts can be deformed due to high temperatures during the injection process, causing inappropriate aberration on the manufactured diffraction element. If the plastics and the molds are at lower temperatures, the diffraction element can be produced appropriately. However, that decreases the transcription capability due to lower resin filling rate, causing inappropriate aberration on the manufactured diffraction element.

The present invention has been made in view of the above points and is intended to provide a diffraction element, optical pickup and optical disc apparatus with good characteristics.

In one aspect of the present invention, a diffraction element includes: an injection-molded transparent first member having two optical surfaces; and a second member firmly attached to one of the optical surfaces of the first member and provided with a first diffraction pattern on a surface, wherein the second member is a first ultraviolet curable resin having a refraction index in a range of ±0.013 with respect to a refraction index of the first member.

Accordingly, the second member reduces the aberration arising from the first member deformed. Therefore, the aberration between the first and second members is sufficiently decreased for practical use.

In another aspect of the present invention, an optical pickup includes: a light source that emits a first wavelength optical beam, a second wavelength optical beam or a third wavelength optical beam; and an objective lens unit having a diffraction element through which the third wavelength optical beam transmits while the first and second wavelength optical beams are diffracted and a objective lens that collects the first, second or third wavelength optical beam from the diffraction element, wherein the diffraction element including: an injection-molded transparent first member having two optical surfaces; and a second member firmly attached to one of the optical surfaces of the first member and provided with a first diffraction pattern on a surface, wherein the second member is an ultraviolet curable resin having a refraction index in a range of ±0.013 with respect to a refraction index of the first member.

Accordingly, the second member reduces the aberration arising from the first member deformed. Therefore, the aberration between the first and second members is sufficiently decreased for practical use.

In another aspect of the present invention, an optical disc device provided with an optical pickup for emitting a first wavelength optical beam, a second wavelength optical beam or a third wavelength optical beam to an optical disc, the optical pickup including: a light source that emits the first, second or third wavelength optical beam; and an objective lens unit having a diffraction element through which the third wavelength optical beam transmits while the first and second wavelength optical beams are diffracted and a objective lens that collects the first, second or third wavelength optical beam from the diffraction element, wherein the diffraction element including: an injection-molded transparent first member having two optical surfaces; and a second member firmly attached to one of the optical surfaces of the first member and provided with a first diffraction pattern on a surface, wherein the second member is an ultraviolet curable resin having a refraction index in a range of ±0.013 with respect to a refraction index of the first member.

Accordingly, the second member reduces the aberration arising from the first member deformed. Therefore, the aberration between the first and second members is sufficiently decreased for practical use.

In another aspect of the present invention, the diffraction element includes: an injection-molded transparent first member having one surface on which a first diffraction pattern is formed and the other surface being flat; a second member firmly attached to the other surface of the first member and provided with a second diffraction pattern on a surface, the second member being a first ultraviolet curable resin having substantially the same refraction index as that of the first member; and a third member firmly attached to the first diffraction pattern of the first member, the third member being a second ultraviolet curable resin having a different refraction index from that of the first member.

In addition, the second diffraction pattern is formed by pushing a mold that is an inverse of a shape of the second diffraction pattern to the first ultraviolet curable resin applied to the other surface of the first member and emitting ultraviolet rays to solidify the first ultraviolet curable resin. Moreover, the flat surface of the third member is formed by pushing a plane mold to the second ultraviolet curable resin applied to the first diffraction pattern and emitting ultraviolet rays to solidify the second ultraviolet curable resin.

That prevents deformation of the second diffraction pattern and compensates for deformation of the first diffraction pattern, resulting in reduction of the aberration of the diffraction element.

In this manner, the diffraction element, optical pickup and optical disc device according to an embodiment of the present invention include: an injection-molded transparent first member having two optical surfaces; and a second member firmly attached to one of the optical surfaces of the first member and provided with a first diffraction pattern on a surface, wherein the second member is a first ultraviolet curable resin having a refraction index in a range of ±0.013 with respect to a refraction index of the first member. That prevents deformation of the second diffraction pattern and compensates for deformation of the first diffraction pattern, resulting in reduction of the aberration of the diffraction element. Thus, the diffraction element, optical pickup and optical disc device according to an embodiment of the present invention have good optical characteristics.

In addition, the diffraction element, optical pickup and optical disc device according to an embodiment of the present invention include: an injection-molded transparent first member having one surface on which a first diffraction pattern is formed and the other surface being flat; a second member firmly attached to the other surface of the first member and provided with a second diffraction pattern on a surface, the second member being a first ultraviolet curable resin having substantially the same refraction index as that of the first member; and a third member firmly attached to the first diffraction pattern of the first member, the third member being a second ultraviolet curable resin having a different refraction index from that of the first member. That prevents deformation of the second diffraction pattern and compensates for deformation of the first diffraction pattern, resulting in reduction of the aberration of the diffraction element. Thus, the diffraction element, optical pickup and optical disc device according to an embodiment of the present invention have good optical characteristics.

The nature, principle and utility of the invention will become more apparent from the following detailed description when read in conjunction with the accompanying drawings in which like parts are designate by like reference numerals or characters.

### BRIEF DESCRIPTION OF THE DRAWINGS

In the accompanying drawings:

FIG. 1 is a block diagram illustrating the overall configuration of an optical disc device;

FIG. 2 is a schematic diagram illustrating the configuration of an optical pickup;

FIG. 3 is a schematic perspective view of an objective lens unit;

FIG. 4 is a schematic diagram illustrating light paths inside the objective lens unit;

FIGS. 5A to 5C are schematic diagrams illustrating the configuration of a diffraction element;

FIGS. 6A to 6F are schematic diagrams illustrating a method for manufacturing the diffraction element;

FIG. 7 is a schematic diagram illustrating DVD-side aberration;

FIG. 8 is a schematic diagram illustrating base-side aberration;

FIG. 9 is a schematic diagram illustrating a base layer curved;

FIG. 10 is a schematic diagram illustrating base-side aberration;

FIG. 11 is a schematic diagram illustrating the configuration of a diffraction element according to another embodiment of the present invention; and

FIG. 12 is a schematic diagram illustrating the configuration of a diffraction element according to another embodiment of the present invention.

### DETAILED DESCRIPTION OF THE PREFERRED EMBODIMENTS

An embodiment of the present invention will be described in detail with reference to the accompanying drawings.

(1) Configuration of Optical Disc Device

(1-1) Overall Configuration of Optical Disc Device

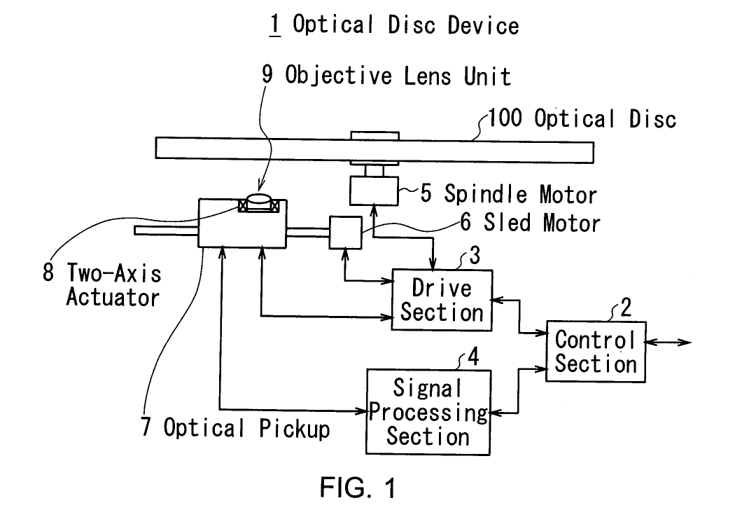

In FIG. 1, the reference numeral 1 denotes an optical disc device with a diffraction element according to an embodiment of the present invention. The optical disc device 1 reproduces signals from an optical disc 100 which is one of the following formats: Compact Disc (CD) type, Digital Versatile Disc (DVD) type or “Blu-ray Disc (Registered Trademark)” (BD) type.

A control section 2 takes overall control of the optical disc device 1. After the optical disc 100 is inserted into the optical disc device 1, the control section 2 controls, in response to a playback command or the like from external devices (not shown), a drive section 3 and a signal processing section 4 to reproduce information from the optical disc 100.

The drive section 3 under the control of the control section 2 controls a spindle motor 5 to rotate the optical disc 100 at appropriate speeds. The drive section 3 also controls a sled motor 6 to bring an optical pickup 7 in a direction of tracking or the radial direction of the optical disc 100. The drive section 3 also controls a two-axis actuator 8 to bring an objective lens unit 9 in a direction of focusing or close to the optical disc 100, or in a direction of tracking away from the optical disc 100.

During those processes, the signal processing section 4 controls the optical pickup 7 to emit an optical beam to the trucks of the optical disc 100 through the objective lens unit 9. After detecting the reflection, the signal processing section 4 reproduces a signal based on the detected result, and then supplies the reproduced signal to the external devices (not shown) through the control section 2.

The optical pickup 7 supports three types of wavelength when emitting the optical beam through the objective lens unit 9; the wavelength of 780 nm of the optical beam for the CD-type optical disc 100c; the wavelength of 650 nm of the optical beam for the DVD-type optical disc 100d; and the wavelength of 405 nm of the optical beam for the BD-type optical disc 100b.

When reproducing signals from the optical disc 100, the optical disc device 1 chooses, in accordance with the type of the optical disc 100, one of the above beams and then emits it to the optical disc 100.

(1-2) Configuration of Optical Pickup

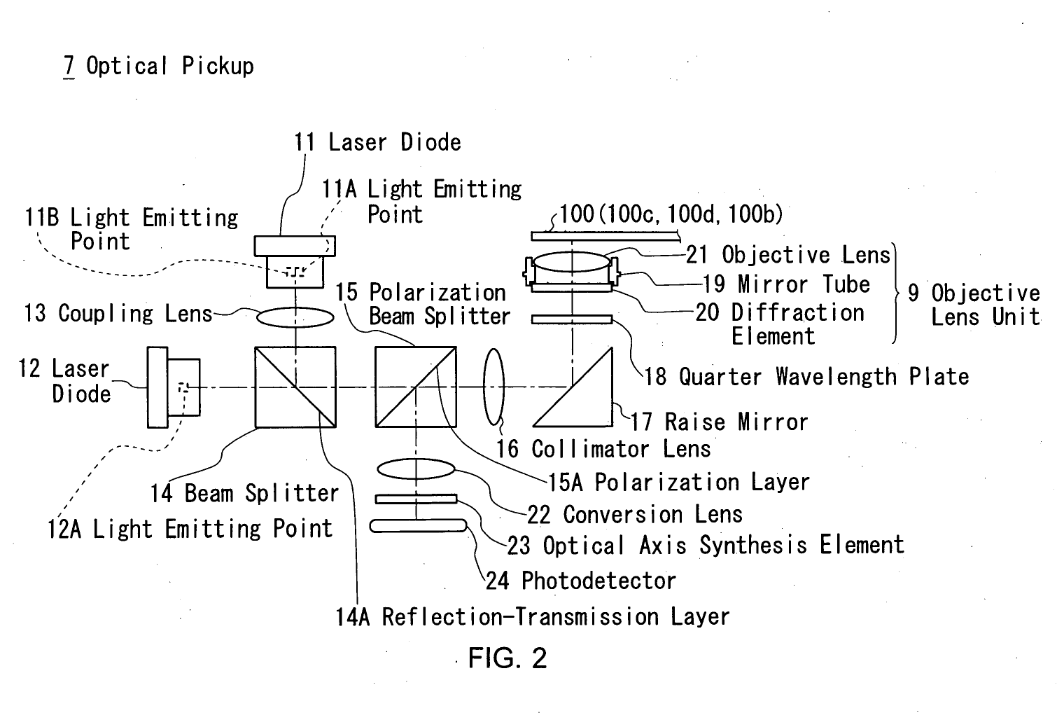

As shown in FIG. 2, the optical pickup 7 includes sources of the optical beams: a laser diode 11 to emit the optical beams of 780 and 650 nm wavelengths for the CD- and DVD-types, respectively; and a laser diode 12 to emit the optical beam of 405 nm wavelengths for the BD-type. The optical beam for CD will be also referred to as a “CD-type optical beam Lc” while the optical beam for DVD and BD will be also referred to as a “DVD-type optical beam Ld” and a “BD-type optical beam Lb”, respectively.

A coupling lens 13 changes the optical magnification of the optical beam from the laser diode 11.

The optical beam of particular wavelengths is reflected on a reflection-transmission layer 14A of a beam splitter 14 while the optical beam with other wavelengths passes through the reflection-transmission layer 14A; the CD-type optical beam Lc of around 780 nm and the DVD-type optical beam Ld of about 650 nm pass are reflected on the reflection-transmission layer 14A while the BD-type optical beam LD of about 405 nm passes through the reflection-transmission layer 14A.

The optical beam with particular polarization angles is reflected on a polarization layer 15A of a polarization beam splitter 15 while the optical beam of other polarization angles passes through the polarization layer 15A; the incident optical beam from the beam splitter 14 passes through the polarization layer 15A while the incident optical beam from a collimator lens 16, whose polarization angles have been adjusted, is reflected on the polarization layer 15A.

The collimator lens 16 collimates the divergent light, which is the incident optical beam from the polarization beam splitter 15, and transforms the collimated optical beam from a raise mirror 17 into convergent light.

The horizontal optical beam from the collimator lens 16 is reflected on the raise mirror 17 and then travels in the vertical direction or a direction perpendicular to the optical disc 100; the vertical optical beam from a quarter wavelength plate 18 is reflected on the raise mirror 17 and then travels in the horizontal direction.

As for a part of the optical beam, its phase is delayed by one quarter of a wavelength through the quarter wavelength plate 18. This transforms the optical beam from the raise mirror 17 from linearly polarized light into circularly polarized light while it transforms the optical beam from the objective lens unit 9 from circularly polarized light into linearly polarized light.

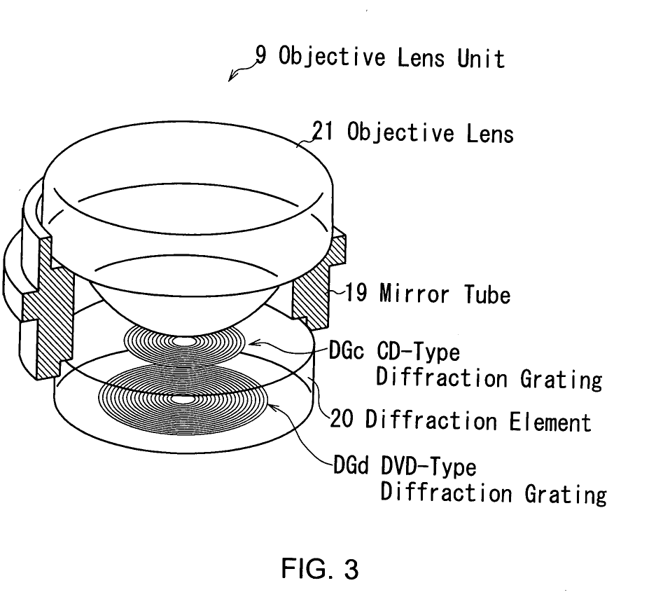

As shown in FIG. 3 where a part of the cutting surface of the objective lens unit 9 is illustrated, a plane disc-shaped diffraction element 20 is attached to the bottom of a mirror tube 19. The objective lens 21 is placed between the top and middle areas of the mirror tube 19; the objective lens 21 includes a disc-shaped section whose size is almost the same as the diffraction element 20 and a smaller-diameter spindle-shaped section which is formed on the under surface of the disc-shaped section.

The objective lens unit 9 transforms the collimated optical beam from the quarter wavelength plate 18 into convergent light through the diffraction element 20 and the objective lens 21 to bring it to a focal point on the optical disc 100.

In the optical pickup 7, the optical beam diverged on the signal recording surface of the optical disc 100 is collimated through the objective lens 21 and diffraction element 20 of the objective lens unit 8. The optical beam is then transformed from circularly polarized light to linearly polarized light through the quarter wavelength plate 18. The optical beam then travels in the horizontal direction to the polarization beam splitter 15 after being reflected on the raise mirror 17. Before getting into the polarization beam splitter 15, the optical beam is transformed from collimated light to convergent light through the collimator lens 16.

In this case, the optical beam with particular polarization angles is reflected on the polarization layer 15A of the polarization beam splitter 15. After that, the optical beam gets into a conversion lens 22.

The conversion lens 22 changes the optical magnification of the CD-type optical beam Lc, the DVD-type optical beam Ld and the BD-type optical beam Lb. A optical axis synthesis element 23 makes the optical axes of the CD-type optical beam Lc and DVD-type optical beam Ld from the laser diode 11 and that of the BD-type optical beam Lb from the laser diode 12 all together.

On the surface of a photodetector 24 that is designed to receive the optical beam from the optical axis synthesis element 23 via the conversion lens 22, a plurality of detection cells in a predetermined shape is formed. The detection cells detect the optical beam and then photoelectric-convert it. The detection cells subsequently supply resultant detection signals to the signal processing section 4 (FIG. 1).

The signal processing section 4 performs a predetermined calculation process and other processes using the detection signals from the photodetector 24 (FIG. 2) to obtain reproduction RF signals, and then performs, based on the reproduction RF signals, predetermined decoding and demodulation processes and the like to produce reproduction signals.

In addition, the signal processing section 4 (FIG. 1) performs, using the detection signals from the photodetector 24 (FIG. 2), a predetermined calculation process and other processes to produce drive control signals such as trucking error signals and focus error signals, and then supplies the drive control signals to the control section 2. As a result, the control section 2 performs, through the drive section 3, control processes such as trucking and focus control to adjust the optical beam to the optical disc 100. In this manner, the reproduction signals are appropriately produced.

(1-2-1) CD-Type Optical Disc

When the control section 2 (FIG. 1) determines, based on a predetermined disc type determination method, that the optical disc 100 is CD-type (100c), the control section 2 controls the laser diode 11 of the optical pickup 7 (FIG. 2) to emit the CD-type optical beam Lc, or divergent light, from the light emitting point 11A to the beam splitter 14 via the coupling lens 13.

The CD-type optical beam Lc is reflected on the reflection-transmission layer 14A of the beam splitter 14, and then passes through the polarization beam splitter 15. The CD-type optical beam Lc is subsequently collimated by the collimator lens 16, and then reflected on the raise mirror 17 to travel in the vertical direction. The CD-type optical beam Lc is subsequently converted by the quarter wavelength plate 18 from linearly polarized light into circularly polarized light, and then reaches the objective lens unit 9.

The objective lens unit 9 converts, through the diffraction element 20 and the objective lens 21, the CD-type optical beam Lc from the quarter wavelength plate 18 into convergent light, and leads it to the focus point on the signal recording surface of the CD-type optical disc 100c.

The objective lens unit 9 subsequently collimates, through the objective lens 21 and the diffraction element 20, the divergent CD-type optical beam Lc which is the reflection from the signal recording surface of the CD-type optical disc 100c, and then leads it to the quarter wavelength plate 18.

After that, in the optical pickup 7, the CD-type optical beam Lc is converted by the quarter wavelength plate 18 from circularly polarized light to linearly polarized light, and then is reflected on the raise mirror 18 to travel in the horizontal direction. The CD-type optical beam Lc is subsequently converted by the collimator lens 16 from collimated light to convergent light, and then reflected on the polarization layer 15A of the polarization beam splitter 15. After that, the CD-type optical beam Lc passes through the conversion lens 22 and the optical axis synthesis element 23 to reach the photodetector 24.

The detection cells of the photodetector 24 detect the CD-type optical beam Lc, and transmit the resultant detection signals to the signal processing section 4 (FIG. 1).

The signal processing section 4 produces, based on the detection signals, the reproduction RF signals, and then generates, based on the reproduction RF signals, the reproduction signals. On the other hand, the signal processing section 4 produces the drive control signals such as trucking error signals and focus error signals.

(1-2-2) DVD-Type Optical Disc

When the control section 2 (FIG. 1) determines, based on a predetermined disc type determination method, that the optical disc 100 is DVD-type (100d), the control section 2 controls the laser diode 11 of the optical pickup 7 (FIG. 2) to emit the DVD-type optical beam Ld, or divergent light, from the light emitting point 11B to the beam splitter 14 via the coupling lens 13. In a similar way to that of the CD-type optical disc 100c, the DVD-type optical beam Ld is reflected on or passes through the following components: the coupling lens 13, the beam splitter 14, the polarization beam splitter 15, the collimator lens 16, the raise mirror 17 and the quarter wavelength plate 18. After that, the DVD-type optical beam Ld is converted into convergent light through the diffraction element 20 and objective lens 21 of the objective lens unit 9, and then is focused on the signal recording surface of the DVD-type optical disc 100d.

After that, in a similar way to that of the CD-type optical disc 100c, the objective lens 21 and diffraction element 20 of the objective lens unit 9 collimate the divergent DVD-type optical beam Ld, which is the reflection from the signal recording surface of the DVD-type optical disc 100d. The DVD-type optical beam Ld is subsequently reflected on or passes through the following components: the quarter wavelength plate 18, the raise mirror 17, the collimator lens 16, the polarization beam splitter 15, the conversion lens 22 and the optical axis synthesis element 23. As a result, the DVD-type optical beam Ld reaches the photodetector 24.

In a similar way to that of the CD-type optical disc 100c, the detection cells of the photodetector 24 detect the DVD-type optical beam Ld, and transmit the resultant detection signals to the signal processing section 4 (FIG. 1).

The signal processing section 4 produces, based on the detection signals, the reproduction RF signals, and then generates, based on the reproduction RF signals, the reproduction signals. On the other hand, the signal processing section 4 produces the drive control signals such as trucking error signals and focus error signals.

(1-2-3) BD-Type Optical Disc

When the control section 2 (FIG. 1) determines, based on a predetermined disc type determination method, that the optical disc 100 is BD-type (100b), the control section 2 controls the laser diode 12 of the optical pickup 7 (FIG. 2) to emit the BD-type optical beam Lb, or divergent light, from the light emitting point 12A to the beam splitter 14.

In this case, the BD-type optical beam Lb passes through the reflection-transmission layer 14A of the beam splitter 14, and goes into the polarization beam splitter 15.

After that, in a similar way to that of the CD-type optical disc 100c, the BD-type optical beam Lb is reflected on or passes through the following components: the polarization beam splitter 15, the collimator lens 16, the raise mirror 17 and the quarter wavelength plate 18. After that, the BD-type optical beam Lb is converted into convergent light through the objective lens 21 of the objective lens unit 9, and then is focused on the signal recording surface of the BD-type optical disc 100b. By the way, in this case, the objective lens unit 9 allows the BD-type optical beam Lb to pass through the diffraction element 20. It means that the diffraction element 20 does not diffract the BD-type optical beam Lb (described later).

After that, in a similar way to that of the CD-type optical disc 100c, the objective lens 21 of the objective lens unit 9 collimates the divergent BD-type optical beam Lb, which is the reflection from the signal recording surface of the BD-type optical disc 100b. The BD-type optical beam Lb is subsequently reflected on or passes through the following components: the quarter wavelength plate 18, the raise mirror 17, the collimator lens 16, the polarization beam splitter 15, the conversion lens 22 and the optical axis synthesis element 23. As a result, the BD-type optical beam Lb reaches the photodetector 24.

In a similar way to that of the CD-type optical disc 100c, the detection cells of the photodetector 24 detect the BD-type optical beam Lb, and transmit the resultant detection signals to the signal processing section 4 (FIG. 1).

The signal processing section 4 produces, based on the detection signals, the reproduction RF signals, and then generates, based on the reproduction RF signals, the reproduction signals. On the other hand, the signal processing section 4 produces the drive control signals such as trucking error signals and focus error signals.

In this manner, the optical pickup 7 supports the CD-type optical disc 100c, the DVD-type optical disc 100d and the BD-type optical disc 100b: with the objective lens unit 9, the CD-type optical beam Lc, the DVD-type optical beam Ld and the BD-type optical beam Lb are focused on the signal recording surface of the optical disc 100 appropriately, and their reflection are correctly detected by the photodetector 24.

(1-3) Configuration of Objective Lens Unit

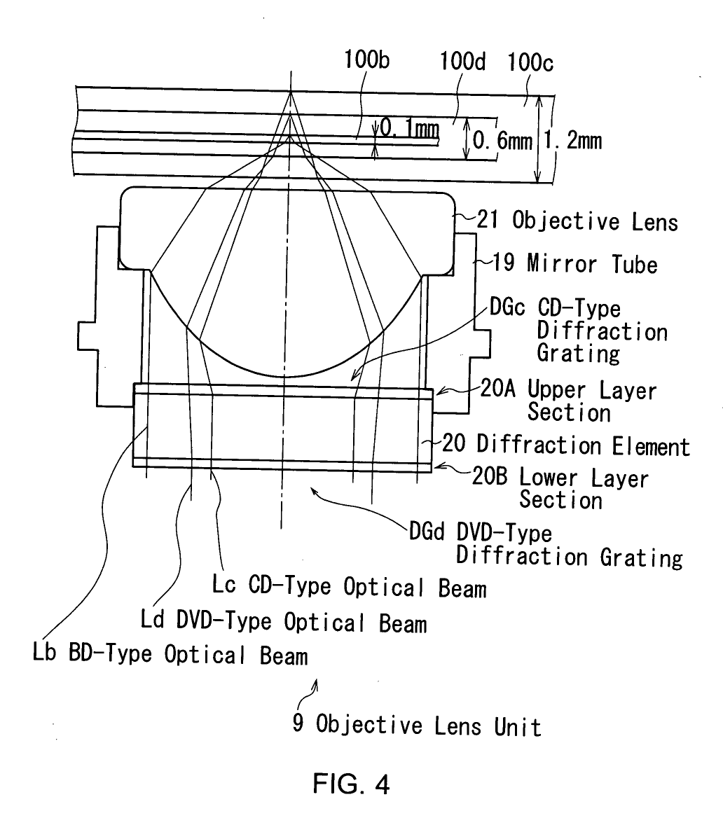

FIG. 4 is an enlarged sectional view of the CD-type optical disc 100c, the DVD-type optical disc 100d, the BD-type optical disc 100b and the objective lens unit 9.

By the way, FIG. 4 does not illustrate the two-axis actuator 8 (FIG. 1) which is attached to the objective lens unit 9.

As for CD-, DVD- and BD-types, the following are standardized for compatibility: the wavelengths of optical beam to read out information; numerical apertures for collecting the optical beam; and the thickness of the optical discs 100 between the lower surface and the signal recording surface, or the thickness of the cover layer.

In reality, the CD-type optical disc is standardized in the following manner: the wavelength is approximately 780 nm; numerical apertures are approximately 0.45; and the thick of the cover layer is 1.2 mm. The DVD-type optical disc is standardized in the following manner: the wavelength is approximately 650 nm; numerical apertures are approximately 0.65; and the thick of the cover layer is 0.6 mm. The BD-type optical disc is standardized in the following manner: the wavelength is approximately 405 nm; numerical apertures are approximately 0.85; and the thick of the cover layer is 0.1 mm.

In addition, as for the CD-type optical beam Lc, the DVD-type optical beam Ld and the BD-type optical beam Lb, their focal distances, the distances between the objective lens 21 and their focal points, are different due to the characteristics of the objective lens 21.

Accordingly, in the optical disc device 1, the two-axis actuator 8 (FIG. 1) adjusts the distance between the objective lens unit 9 and the optical disc 100 to have the optical beam focused on the signal recording surface of the optical discs: the two-axis actuator 8 appropriately positions the objective lens unit 9 with respect to the optical disc 100 fixed at predetermined position.

By the way, for ease of explanation, FIG. 4 illustrates the optical discs 100 whose positions are being adjusted with respect to the fixed objective lens unit 9, resulting in different distances between the objective lens 9 and each optical disc's lower surface. In addition, FIG. 4 only illustrates the cover layers of the CD-type optical disc 100c, DVD-type optical disc 100d and BD-type optical disc 100b.

Considering the relative intensity of the BD-type optical beam Lb, the numerical apertures for BD-type and the like, the objective lens 21 is mainly designed for the BD-type optical beam Lb rather than the CD-type optical beam Lc and the DVD-type optical beam Ld.

Accordingly, when the collimated BD-type optical beam Lb reaches the lower surface of the objective lens 21 of the objective lens unit 9, the objective lens 21 converts this incident BD-type optical beam Lb into convergent light to have it focused on the signal recording surface of the BD-type optical disc 100b.

However, the objective lens 21 is designed for the BD-type optical beam Lb as mentioned above: if the collimated CD-type optical beam Lc or DVD-type optical beam Ld gets into the objective lens 21 via its lower surface, it may cause an aberration while the objective lens 21 converts it into convergent light. As a result, the optical beam may not be focused on the signal recording surface of the optical disc 100 appropriately.

Accordingly, the diffraction element 20 of the objective lens unit 9 only diffracts the CD-type optical beam Lc and DVD-type optical beam Ld to supply them to the objective lens 21 as non-collimated light. On the other hand, as the collimated BD-type optical beam comes in, the diffraction element 20 supplies it to the objective lens 21 as collimated light.

As a matter of fact, on an upper layer section 20A of the diffraction element 20, a diffraction grating for CD (also referred to as “CD-type diffraction grating”) DGc, or hologram, is formed to diffract only the CD-type optical beam Lc, not the DVD-type optical beam Ld and the BD-type optical beam Lb. As shown in FIG. 4, the CD-type optical beam Lc is slightly diffracted outward by the CD-type diffraction grating DGc.

That is to say, the upper layer section 20A of the diffraction element 20 allows the DVD-type optical beam Ld and the BD-type optical beam Lb to pass through it while selectively diffracting the CD-optical beam Lc. In other words, the upper layer section 20A of the diffraction element 20 is designed to only correct the aberration for the CD-type optical beam Lc.

After that, as shown in FIG. 4, the CD-type optical beam Lc from the diffraction element 20 is refracted through the lower and upper surfaces of the objective lens 21. This converts the CD-type optical beam Lc into convergent light. In this manner, the objective lens unit 9 corrects the aberration for the CD-type optical beam Lc, and leads the CD-type optical beam Lc from the objective lens 21 to a focal point on the signal recording surface of the CD-type optical disc lOOc.

In addition, on a lower layer section 20B of the diffraction element 20, a diffraction grating for DVD (also referred to as “DVD-type diffraction grating”) DGd, or hologram, is formed to diffract only the DVD-type optical beam Ld, not the CD-type optical beam Lc and the BD-type optical beam Lb. As shown in FIG. 4, the DVD-type optical beam Ld is slightly diffracted outward by the DVD-type diffraction grating DGd.

That is to say, the lower layer section 20B of the diffraction element 20 allows the CD-type optical beam Lc and the BD-type optical beam Lb to pass through it while selectively diffracting the DVD-optical beam Ld. In other words, the lower layer section 20B of the diffraction element 20 is designed to only correct the aberration for the DVD-type optical beam Ld.

After that, as shown in FIG. 4, the DVD-type optical beam Ld from the diffraction element 20 is refracted through the lower and upper surfaces of the objective lens 21. This converts the DVD-type optical beam Ld into convergent light. In this manner, the objective lens unit 9 corrects the aberration for the DVD-type optical beam Ld, and leads the DVD-type optical beam Ld from the objective lens 21 to a focal point on the signal recording surface of the DVD-type optical disc lood.

In this manner, in the objective lens unit 9, the upper layer section 20A of the diffraction element 20 only corrects the aberration for the CD-type optical beam Lc by diffracting it while the lower layer section 20B of the diffraction element 20 only corrects the aberration for the DVD-type optical beam Ld by diffracting it. That can appropriately lead the CD-type optical beam Lc, the DVD-type optical beam Ld or the BD-type optical beam Lb to focal points of the signal recording surface of the CD-type optical disc 100c, the DVD-type optical disc 100d or the BD-type optical disc 100b even after they pass through the objective lens 21 designed for the BD-type optical beam Lb.

(1-4) Configuration of Diffraction Element

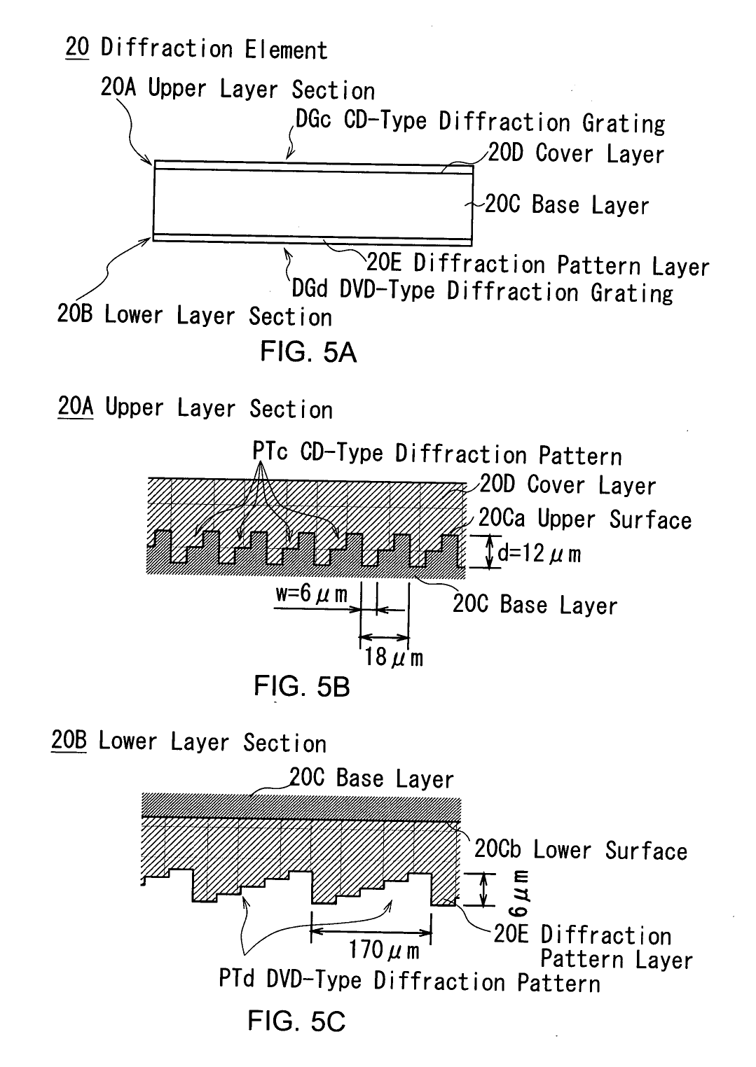

As shown in FIG. 5A, the diffraction element 20 includes a flat, disc-shaped base layer 20C. Its upper layer section 20A includes the CD-type diffraction grating DGc while its lower layer section 20B includes the DVD-type diffraction grating DGd, as mentioned above.

The base layer 20C is for example made from transparent synthetic resin with a predetermined refractive index. Its interface to air or other materials can diffract the optical beam.

FIG. 5B is an enlarged sectional view of the upper layer section 20A. The CD-type diffraction pattern PTc is formed on an upper surface 20c of the base layer 20C: the CD-type diffraction pattern PTc includes a plurality of step-like protruding parts located at certain intervals. The CD-type diffraction pattern PTc is covered by a cover layer 20D that is for example made from transparent cured resin.

The step-like CD-type diffraction pattern PTc (also referred to as a “first diffraction pattern”) includes three steps for each protruding part: the height of the protruding parts from bottom to top is 12 μm; and the interval of protruding parts, or the distance between one protruding part to the adjoining protruding part, is 18 μm. As shown in FIG. 3, the CD-type diffraction pattern PTc is concentrically formed on the upper surface of the diffraction element 20 within one-half radius from the center.

The cover layer 20D (also referred to as a “third member”) is made from a certain material whose refraction index is different from that of the base layer 20C (the base layer 20C is also referred to as a “first member”). A lower surface of the cover layer 20D is attached to the CD-type diffraction pattern PTc (or the first diffraction pattern) without no space between them. An upper surface of the cover layer 20D is substantially flat.

In this manner, the upper layer section 20A of the diffraction element 20 includes the step-like CD-type diffraction pattern PTc whose protruding portions are located at certain intervals on the upper surface 20Ca of the base layer 20C. On the CD-type diffraction pattern PTc, the cover layer 20D is formed: the refraction index of the cover layer 20D is different from that of the base layer 20C. Accordingly, the upper layer section 20A diffracts the optical beam of particular wavelengths while allowing the optical beam of other wavelengths to pass through it. In this case, the diffraction element 20 includes the CD-type diffraction grating DGc that only diffracts the CD-type optical beam Lc (the CD-type optical beam Lc is also referred to as an “optical beam of a first wavelength”).

FIG. 5C is an enlarged sectional view of the lower layer section 20B. A diffraction pattern layer 20E including a DVD-type diffraction grating DGd is attached to a flat lower surface 20Cb of the base layer 20C.

The diffraction pattern layer 20E (also referred to as a “second member”) is made from transparent resin whose refractive index is substantially the same as that of the base layer 20 (or first member). This point will be described later. The step-like protruding portions are formed at certain intervals on its bottom side as the DVD-type diffraction pattern PTd. The lower surface of the diffraction pattern layer 20E is an interface to air because it is not covered by any materials.

The step-like DVD-type diffraction pattern PTd (also referred to as a “second diffraction pattern”) includes five steps for each protruding part: the height of the protruding parts from bottom to top is 6 μm; and the interval of protruding parts, or the distance between one protruding part to the adjoining protruding part, is 170 μm. As shown in FIG. 3, the DVD-type diffraction pattern PTd is concentrically formed on the lower surface of the diffraction element 20 within two-thirds radius from the center.

In this manner, the lower layer section 20B of the diffraction element 20 includes the step-like DVD-type diffraction pattern PTd (or a second diffraction pattern) whose protruding portions are located at certain intervals on the diffraction pattern layer 20E attached to the lower surface of the base layer 20C. The lower layer section 20B diffracts the optical beam of particular wavelengths while allowing the optical beam of other wavelengths to pass through it. In this case, the diffraction element 20 includes the DVD-type diffraction grating DGd that only diffracts the DVD-type optical beam Ld (the DVD-type optical beam Ld is also referred to as an “optical beam of a second wavelength”).

(2) Method for Manufacturing Diffraction Elements

A production method for the diffraction elements 20 will be described. As mentioned above, the cover layer 20D and the diffraction pattern layer 20E are attached to the upper and lower surfaces of the base layer 20C, respectively.

The base layer 20 is produced by injection molding in the following manner: transparent resin with a predetermined refractive index, such as polyolefin, is injected into a mold. As shown in FIG. 5B, the CD-type diffraction pattern PTc is formed on the upper surface 20Ca of the base layer 20C. As for grooves of the CD-type diffraction pattern PTc, their aspect ratio of depth d to width w is represented as R: R=12 μm/6 μm=2.

That means that the diffraction pattern on the base layer 20C has a relatively big aspect ratio, or relatively deep and narrow grooves. Accordingly, it is preferable to improve the reproducibility for the diffraction pattern (or its transcription capability) to injection mode the base layer 20C. This may require raising the resin filling rate of the mold by keeping resin and mold temperatures at high. In addition, it may be necessary to raise the temperature of the plastics after the injection process to easily take the parts from the mold. However, when parted from the mold the base layer 20C may be deformed due to high temperature of the resin, causing inappropriate aberration.

Accordingly, in this embodiment, the cover layer 20D and the diffraction pattern layer 20E, both are being formed on the upper and lower surfaces of the injection-molded base layer 20C, are made from UV curable resin (UV: Ultra Violet ray). It means that the UV replica technique is applied. Thus, the deformation of the base layer 20C is compensated by the cover layer 20D and the diffraction pattern layer 20E in terms of optics. This maintains the optical characteristics of the diffraction element 20.

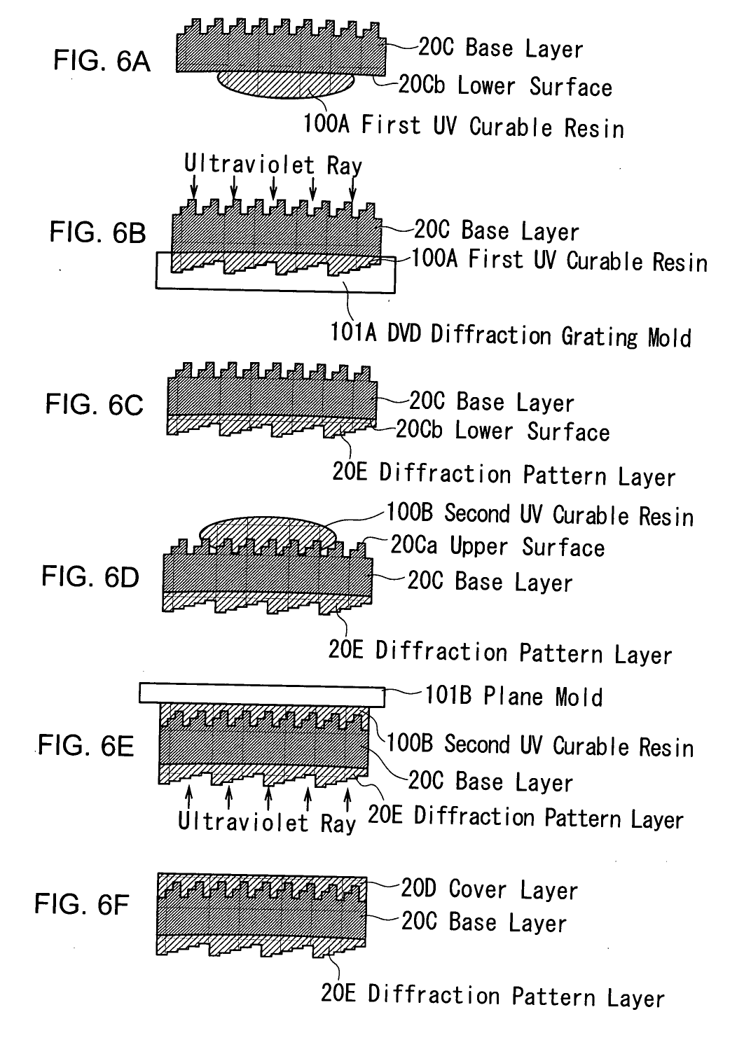

The method of manufacturing the diffraction element 20 is this: as shown in FIG. 6A, a first UV curable resin 100A whose refraction index is almost the same as that of the resin from which the inject-molded base layer 20 is made is applied to the lower surface 20Cb of the base layer 20C.

Then, as shown in FIG. 6B, a DVD diffraction grating mold 101A, which is a press member, or the inverse of the shape of the DVD-type grating pattern PTd (FIG. 5C), is applied to the UV curable resin 100A on the lower surface 20Cb. An ultraviolet ray source (not shown) then emits ultraviolet rays to the upper surface of the base layer 20C to solidify the resin. As a result, the first UV curable resin 100A is solidified in the DVD diffraction grating mold 101A. In this manner, as shown in FIG. 6C, the diffraction pattern layer 20E having the DVD-type diffraction pattern PTd is formed on the lower surface 20Cb of the base layer 20C with no space between them.

As mentioned above, the base layer 20C has been deformed as a result of injection molding, which also causes deformation of the lower surface 20Cb that should have been flat. However, since the refraction index of the UV curable resin 100A of the diffraction pattern layer 20E is substantially the same as that of the base 20C, the diffraction pattern layer 20E is assimilated with the base layer 20C in terms of optics. This compensates for the deformation of the lower surface 20Cb where the diffraction pattern 20E meets the base layer 20C.

After the diffraction pattern layer 20E is formed, as shown in FIG. 6D, a second UV curable resin 100B whose refraction index is different from that of the resin from which the base layer 20C is made is applied to the upper surface 20Ca of the base layer 20C: the resin of the base layer 20C has the refraction index of n_{BASE}=1.5 while that of the second UV curable resin 100B is n_{UV2}=1.6, for example.

Then, as shown in FIG. 6E, a plane surface of a plane mold 101B, which is a press member, is applied to the second UV curable resin 100B to have the second UV curable resin 100B covering the CD-type diffraction pattern PTc (FIG. 5C) formed on the upper surface 20Ca of the base layer 20C with no space between them. Subsequently, an ultraviolet ray is applied to the lower surface of the base layer 20C to solidify the second UV curable resin 100B. This produces the plane cover layer 20E on the CD-type diffraction pattern PTc (FIG. 6F).

In this case, the CD-type diffraction pattern PTc on the upper surface 20Ca of the base layer 20C has been deformed due to injection molding, which may cause an aberration. Generally, the optical beam is diffracted according to the refraction indexes of the adjoining two layers with the diffraction pattern: the larger the difference between those refraction indexes is, the more the aberration due to the deformation of the diffraction pattern can rise.

Generally, the diffraction patterns of general diffraction elements are directly exposed to air: the difference between the refraction index of the diffraction element and that of air (n_{AIR}=1) is large. By contrast, with the diffraction element 20 according to an embodiment of the present invention, the CD-type diffraction pattern PTc is covered with the cover layer 20D, which can minimize the difference of the refraction indexes of the base layer 20C and cover layer 20D. This eliminates the aberration which is caused by the deformation of the CD-type diffraction pattern PTc.

For instance, the difference of the refraction indexes when the base layer 20 (whose refraction n_{BASE} is 1.5) is directly expose to air is represented as Δn1: Δn1=n_{BASE}−n_{AIR}=1.5−1=0.5. On the other hand, the difference of the refraction indexes when the base layer 20C is covered with the cover layer 20D (whose refraction index n_{UV2} is 1.6) is represented as Δn2: Δn2=n_{BASE}−n_{UV2}=1.5−1.6=−0.1. Accordingly, the diffraction element 20 according to an embodiment of the present invention minimizes the difference of the refraction indexes, which leads to decrease of the aberration caused by the deformation of the diffraction pattern to approximately 17%. In addition, since the surface of the cover layer 20D, which is the second UV curable resin 100B exposed to air with relatively high refraction indexes difference, has been flattened by the plane mold 101B, the aberration on the surface of the cover layer 20D can be also minimized.

(3) Selection of Materials for Diffraction Pattern Layers

To minimize the aberration of the diffraction element 20 for practical use, it is desirable that the aberration of the diffraction pattern layer 20E having the DVD-type diffraction pattern PTd should be kept under 0.025 λrms (the aberration of the diffraction pattern layer 20E will be also referred to as “DVD-side aberration”).

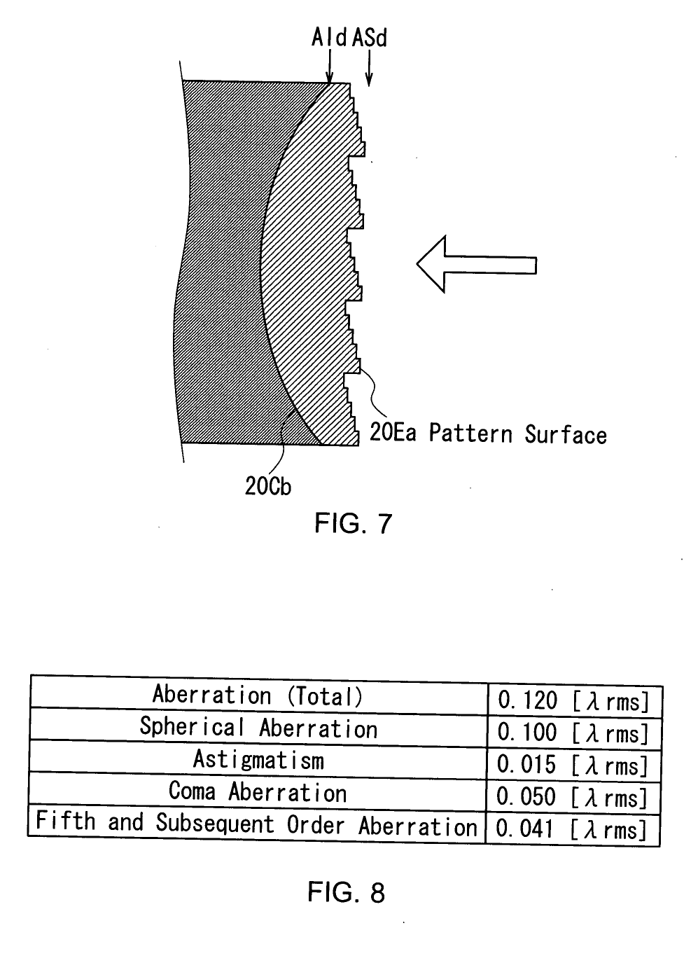

As shown in FIG. 7, the DVD-side aberration includes: a DVD-side surface aberration ASd, due to the deformation of the surface of the DVD-type diffraction pattern PTd (the surface of the DVD-type diffraction pattern PTd will be also referred to as a “pattern surface 20Ea”); and a DVD-side base aberration AId between the diffraction pattern layer 20E and the base layer 20C, due to the deformation of the base layer 20C.

By the way, the diffraction pattern layer 20E of the diffraction element 20 is produced by the above-mentioned UV replica technique. However, the slight deformation of the pattern surface 20Ea causes the DVD-side surface aberration ASd of approximately 0.007 λrms.

Accordingly, it is desirable to keep the DVD-side base aberration AId less or equal to 0.018 λrms to have the diffraction element 20 whose DVD-side aberration is less or equal to 0.025 λrms.

By the way, injection molding causes relatively large deformation on the base layer 20C.

FIG. 8 shows the aberration of the light that passes through the base layer 20C exposed directly to air. This aberration is caused by the deformation of the base layer 20C (whose refraction index n_{BASE} is 1.525) that is produced under the following condition: the temperature of the mold is 135 degrees Celsius; the temperature of the resin is 270 degrees Celsius; and the pressure during injection molding is 650 kg/cm². FIG. 8 shows the fact that the base layer 20C has the total aberration of 0.12 λrms. By the way, the total aberration is calculated by the processes of: multiplying each aberration (spherical aberration, astigmatism, coma aberration and fifth and subsequent order aberration) by itself; totalizing them; and then extracting the square root of it.

As shown in FIG. 9, the base layer 20C is deformed as a result of injection molding, resulting in warpage of base layer 20C. Accordingly, the concave lower surface 20Cb has a larger curvature (or deformation) than that of the upper surface 20Ca. The aberration of the light reflected on the lower surface 20Cb and the upper surface 20Ca can be calculated from the total number of aberration of the transmitted light which passes through the base layer 20C exposed directly to air: 0.20 λrms 0.08 λrms, respectively. Therefore, the number of aberration of the transmitted light for the lower surface 20Cb is 0.80 λrms.

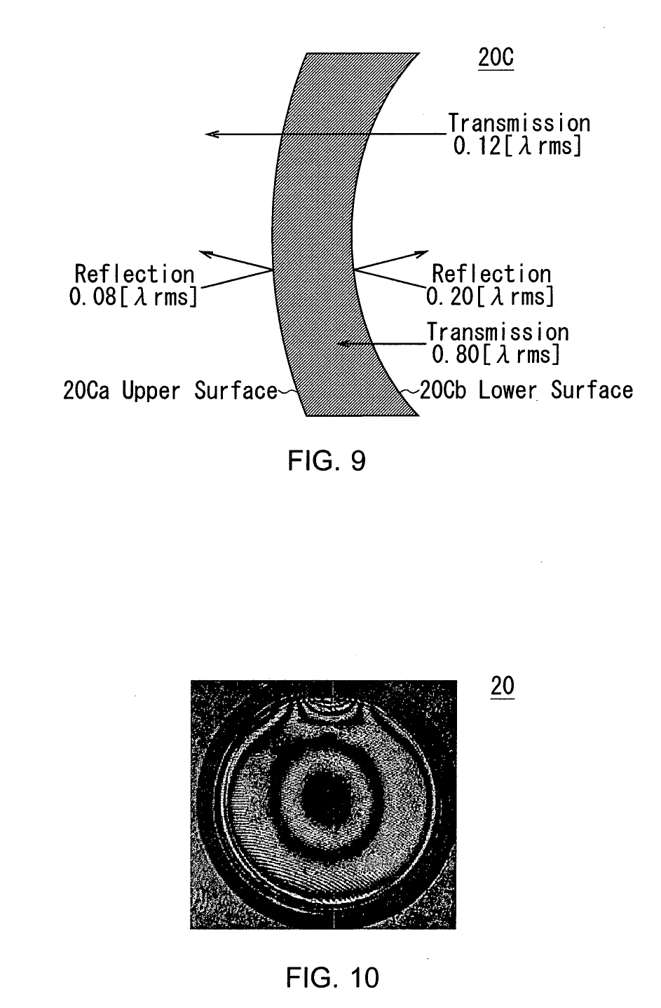

By the way, FIG. 9 highlights the curved part of the base layer 20C and omits the CD-type diffraction pattern PTc on the upper surface 20Ca. FIG. 10 illustrates fringes, which are the contour lines of the wavefronts of the transmitted light that passes through the base layer 20C: the fringes are distorted. This means that, because the aberration of the transmitted light that passes through the base layer 20C exposed directly to air is rather large, this base layer 20C may be not suitable for practical use.

The aberration of the base layer 20C is determined according to the difference of the refraction indexes Δn and aberration between the base layer 20C and materials covering the base layer 20C. If the base layer 20C (whose refraction n_{BASE} is 1.525) is covered by “air (whose refraction n_{AIR} is 1.0)”, their refraction indexes difference becomes rather large, or Δn3=1.525−1.0=0.525. This causes a relatively large aberration of 0.80 λrms on the lower surface 20Cb.

Thus, the diffraction element 20 is designed to lower the difference of refraction indexes Δn4 between the base layer 20C and the diffraction pattern layer 20E covering the base layer 20C. This keeps the DVD-side base aberration AId less or equal to the target or 0.018 λrms.

In effect, given that the aberration of the lower surface 20Ca exposed directly to air is 0.80 λrms, the difference of refraction indexes Δn4 between the diffraction pattern layer 20E and the base layer 20C will be less than 0.025 (=0.018/0.80) of the difference of refraction indexes Δn3 between air and the base layer 20C to keep the DVD-side base aberration AId less or equal to the target of 0.018 λrms.

In this case, the difference of refraction indexes Δn3 between air and the base layer 20C is 0.525. This means: Δn3×0.025=0.013.

Accordingly, the material of the diffraction pattern layer 20E (or the first UV curable resin 100A) is chosen to keep the refraction index n_{UV1} of the diffraction pattern layer 20E within a range of 1.525±0.013, resulting in the desired level of the DVD-side aberration of 0.025 λrms.

In this case, the diffraction pattern layer 20E of the diffraction element 20 has the refraction index n_{UV1} of 1.537, and the difference of refraction indexes Δn4 between the diffraction pattern layer 20E and the base layer 20C is +0.012.

That maintains the DVD-side base aberration of the diffraction element 20 less or equal to 0.018 λrms, and the DVD-side aberration at 0.025 λrms (=0.018+0.007).

By the way, the diffraction pattern layer 20E, which has a higher capability of correcting the aberration than the cover layer 20D, is attached to the lower surface 20Cb which has large aberration. This reduces the total aberration of the diffraction element 20.

(4) Operation and Effect

The diffraction element 20 with the above configuration includes the base layer 20C which is produced by injection molding. On the lower surface 20Cb of the base layer 20C, the diffraction pattern layer 20E having the precise DVD-type diffraction pattern PTd is formed by the UV replica technique. Using the base layer 20C and diffraction pattern layer 20E having the same refraction index reduces the aberration caused by the lower surface 20Cb deformed.

In addition, the CD-type diffraction pattern PTc on the upper surface 20Ca of the base layer 20 is covered with the flat-surface cover layer 20D by the UV replica technique. This reduces the difference of refraction indexes around the CD-type diffraction pattern PTc, resulting in reduction of the aberration caused by the CD-type diffraction pattern PTc deformed.

Moreover, the material of the diffraction pattern layer 20E is selected to keep the difference of refraction indexes Δn4 between the base layer 20C and the diffraction pattern layer 20E within a range of ±0.013. Accordingly, the DVD-side aberration can be maintained at less or equal to 0.025 λrms, which is good enough for practical use. Thus, the diffraction element 20 has good optical characteristics.

Furthermore, the diffraction pattern layer 20E, which has a high capability of correcting the aberration, is attached to the lower surface 20Cb which has large aberration due to its curved concave surface. This reduces the total aberration of the diffraction element 20.

The above configuration makes this possible: the UV replica technique is applied to form the diffraction pattern layer 20E and the cover layer 20D that optically correct the deformation of the base layer 20C which is produced by injection molding. Thus, the diffraction element 20 for three types of wavelengths has good optical characteristics.

### (5) OTHER EMBODIMENTS

In the above-noted embodiments, the diffraction pattern layer 20E having the DVD-type diffraction pattern PTd is formed, by the UV replica technique, on the flat lower surface 20Cb of the base layer 20C. In addition, the CD-type diffraction pattern PTc on the base layer 20C is covered with the flat-surface cover layer 20D. However, the present invention is not limited to this. A diffraction pattern layer may be formed on the surface of the cover layer 20D.

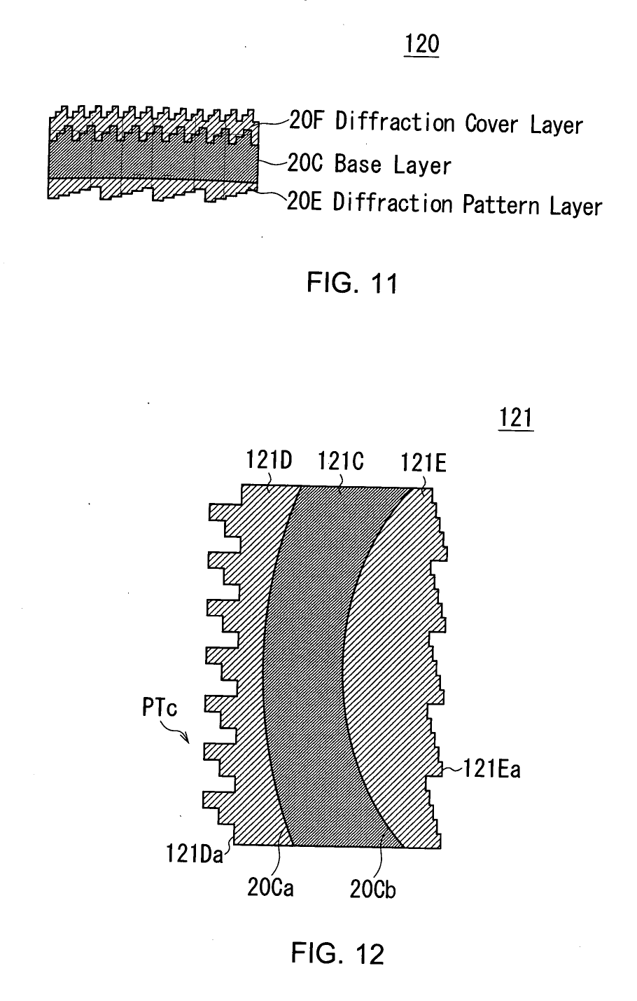

FIG. 11 shows another example of the diffraction element: in a similar way to that of the diffraction element 20 (FIG. 6), a diffraction pattern layer 20E is formed, by the UV replica technique, on a flat surface of an injection-molded base layer 20C of the diffraction element 120; and on the other surface of the base layer 20C where the diffraction pattern has been formed, the diffraction cover layer 20F is formed by the UV replica technique. This diffraction cover layer 20F has a diffraction pattern formed on its surface. That produces the diffraction element 120 for four types of wavelengths with good optical characteristics.

FIG. 12 shows another example of the diffraction element: upper and lower surfaces of an injection-molded base layer 121C are both flat; a diffraction pattern layer 121E having a DVD-type diffraction pattern PTd on its surface is formed, by the UV replica technique, on one surface of the base layer 121C; and a diffraction pattern layer 121D having a CD-type diffraction pattern PTc on its surface is formed, by the UV replica technique, on the other surface of the base layer 121C.

In this case, the aberration of the transmitted light for the convex upper surface 20Ca when the upper surface 20Ca is directly exposed to air is 0.32 λrms. Accordingly, the material of the diffraction pattern layer 121D is selected to keep the difference of refraction indexes Δn2a between the base layer 121C and the diffraction pattern layer 121D within a range of ±0.013. This reduces the aberration of the upper surface 20Ca to 0.007 λrms. As a result, the aberration of the diffraction pattern layer 121D can be reduced to 0.014 λrms (=0.007+0.007) because the aberration on the diffraction pattern surface 121Da is 0.007 λrms. Accordingly, the total aberration of the diffraction element 121 is maintained at 0.039 λrms (=0.014+0.025), which is good enough for practical use because it is under 0.040 λrms.

If the diffraction pattern layers 121D and 121E have different refraction indexes n_{UV1} and n_{UV2}, the diffraction pattern layer 121D or 121E is selectively formed on the lower surface 20Cb such that the difference of refraction indexes between the base layer 121 and the diffraction pattern layer becomes smaller. This compensates for the relatively-large aberration of the lower surface 20Cb, resulting in reduction of the total aberration of the diffraction element 121.

The diffraction element, optical pickup and optical disc device according to an embodiment of the present invention can be applied to optical elements that support various wavelengths of optical beam.

It should be understood by those skilled in the art that various modifications, combinations, sub-combinations and alterations may occur depending on design requirements and other factors insofar as they are within the scope of the appended claims or the equivalents thereof.

What is claimed is:

1. A diffraction element including:
an injection-molded transparent first member having two optical surfaces; and
a second member firmly attached to one of the optical surfaces of the first member and provided with a first diffraction pattern on a surface, wherein
the second member is a first ultraviolet curable resin having a refraction index in a range of ±0.013 with respect to a refraction index of the first member.

2. The diffraction element according to claim 1, including
a third member firmly attached to the other of the optical surfaces of the first member and provided with a second diffraction pattern on a surface, wherein
the third member is a second ultraviolet curable resin having a refraction index in a range of ±0.013 with respect to the refraction index of the first member.

3. The diffraction element according to claim 2, wherein
a difference of refraction indexes between the second member and the first member is smaller than a difference of refraction indexes between the third member and the first member; and
the second member is firmly attached to the one of the optical surfaces, wherein the one of the optical surfaces is a concave surface having a large curvature.

4. The diffraction element according to claim 1, wherein
the first diffraction pattern is formed by pushing a press member having an inverse of a shape of the first diffraction pattern to the first ultraviolet curable resin applied to the one of the optical surfaces and emitting ultraviolet rays to solidify the first ultraviolet curable resin, the one of the optical surfaces being flat.

5. The diffraction element according to claim 1, wherein
the third member is formed by pushing a press member having an inverse of a shape of the second diffraction pattern to the second ultraviolet curable resin applied to the second diffraction pattern and emitting ultraviolet rays to solidify the second ultraviolet curable resin.

6. The diffraction element according to claim 1, wherein
the one of the optical surfaces of the first member is a plane surface to which the second member is firmly attached, and
the other of the optical surfaces of the first member is provided with a second diffraction pattern to which a third member is firmly attached, the third member being a second ultraviolet curable resin having a different refraction index from that of the first member.

7. The diffraction element according to claim 6, wherein
the third member has a plane surface, the plane surface being formed by pushing a plane press member to the second ultraviolet curable resin applied to the second diffraction pattern and emitting ultraviolet rays to solidify the second ultraviolet curable resin.

8. The diffraction element according to claim 6, wherein
the third member has a third diffraction pattern on a surface, the third diffraction pattern being formed by pushing a press member having an inverse of a shape of the third diffraction pattern to the second ultraviolet curable resin applied to the second diffraction pattern and emitting ultraviolet rays to solidify the second ultraviolet curable resin.

9. An optical pickup comprising:
a light source that emits a first wavelength optical beam, a second wavelength optical beam or a third wavelength optical beam; and
an objective lens unit having a diffraction element through which the third wavelength optical beam transmits while the first and second wavelength optical beams are diffracted and a objective lens that collects the first, second or third wavelength optical beam from the diffraction element, wherein
the diffraction element including:
an injection-molded transparent first member having two optical surfaces; and
a second member firmly attached to one of the optical surfaces of the first member and provided with a first diffraction pattern on a surface, wherein the second member is an ultraviolet curable resin having a refraction index in a range of ±0.013 with respect to a refraction index of the first member.

10. The optical pickup according to claim 9, wherein
the diffraction element further including
a third member firmly attached to a second diffraction pattern formed on the other of the optical surfaces of the first member, the third member being a second ultraviolet curable resin having a different refraction index from that of the first member, wherein
the one of the optical surfaces of the first member is a plane surface to which the second member is firmly attached.

11. The optical pickup according to claim 9, wherein
the first diffraction pattern diffracts only the first wavelength optical beam, and
the second diffraction pattern diffracts only the second wavelength optical beam.

12. An optical disc device provided with an optical pickup for emitting a first wavelength optical beam, a second wavelength optical beam or a third wavelength optical beam to an optical disc, the optical pickup including:
a light source that emits the first, second or third wavelength optical beam; and
an objective lens unit having a diffraction element through which the third wavelength optical beam transmits while the first and second wavelength optical beams are diffracted and a objective lens that collects the first, second or third wavelength optical beam from the diffraction element, wherein
the diffraction element including:
an injection-molded transparent first member having two optical surfaces; and
a second member firmly attached to one of the optical surfaces of the first member and provided with a first diffraction pattern on a surface, wherein the second member is an ultraviolet curable resin having a refraction index in a range of ±0.013 with respect to a refraction index of the first member.

13. The optical disc device according to claim 12, wherein
the diffraction element further including
a third member firmly attached to a second diffraction pattern formed on the other of the optical surfaces of the first member, the third member being a second ultraviolet curable resin having a different refraction index from that of the first member, wherein
the one of the optical surfaces of the first member is a plane surface to which the second member is firmly attached.
